(19) United States
(12) Patent Application Publication
(10) Pub. No.: US 2008/0305735 A1
(43) Pub. Date: Dec. 11, 2008

(54) MOBILE TELEPHONE JAMMING SYSTEM FOR AUTOMOBILES

(76) Inventors: John Farnsworth, South Jordan, UT (US); Randall B. Bateman, Sandy, UT (US)

Correspondence Address: BATEMAN IP LAW GROUP, P.O. BOX 1319, SALT LAKE CITY, UT, 84110, US

(21) Appl. No.: 11/866,351

(22) Filed: Oct. 2, 2007

Related U.S. Application Data
(60) Provisional application No. 60/942,158, filed on Jun. 5, 2007.

(51) Int. Cl. H04K 3/00; H04M 1/00

(52) U.S. Cl. 455/1; 455/230; 455/344; 455/456.4; 455/569.2

(57) ABSTRACT

A mobile telephone jamming system for automobiles includes circuitry for jamming mobile telephone communications and a mechanism for an authorized person to selectively turn off the jamming. It may also include one or more switches or sensors, such as the ignition switch, a speed sensor, or an on-off switch to selectively control when the mobile telephone jamming system interferes with mobile telephone calls.

### RELATED APPLICATIONS

The present application claims the benefit of U.S. Provisional Application No. 60/942,158, filed Jun. 5, 2007.

### BACKGROUND

1. The Field of the Invention

The present invention relates to a system for preventing a driver from engaging in a mobile telephone call while driving an automobile. More specifically, the present invention relates to systems and method for jamming mobile calls so that a driver will not be impaired while driving an automobile, thereby reducing the risk of accident caused by driver distraction.

2. State of the Art

The use of mobile telephones has increased dramatically over the last 20 years. While initially, a rarity, mobile telephones have grown to the point where many individuals simply use a mobile telephone and no longer have telephone service to their home.

Mobile telephones are advantageous because they are not confined to any particular area. The telephone is able to move from one area (or cell) to another by simple making connection with an antenna in the new area and terminating the connection with the antenna in the area or cell which is being exited. This allows a very broad range of travel for a mobile telephone. Mobile telephones which can operate on both analog and digital networks can be used through most of the United States.

The widespread adoption of mobile telephones and common use of the devices while driving has raised concerns about the distraction of drivers. A driver speaking on a mobile telephone may be mentally distracted from the traffic situation in front of or to the sides of the vehicle that he or she is driving. Thus, it is not uncommon to see an individual involved in an accident who was speaking on a mobile telephone rather than paying attention to the road. Furthermore, many drivers will be holding the mobile telephone in one hand and using only one hand to control the steering wheel. If the driver is driving an automobile with a standard or manual transmission, the driver may even remove that hand from the wheel in order to shift gears. Thus, at least for a few moments, the driver has no control over the steering wheel.

The increased use of mobile telephone related communications, such as text messaging, further heightens concerns. A driver attempting to read a text message is both mentally distracted and visually distracted from the traffic situation at hand. Additionally, a driver attempting to send a text message does not have control of the steering wheel. This results in a vehicle which is without a moment of being out of control.

Studies now suggest that individuals speaking on mobile telephones while driving a car may be as impaired as a person who drives while intoxicated. Not only is the driver mentally distracted, but eyes of the driver are diverted for dialing, looking to see who an incoming call is from, etc.

While distracted drivers are a problem, it is of special concern with drivers who have little driving experience. For example, an experienced driver may be less distracted and more able to function properly while talking on a cell phone than may a teenager or other individual with little driving experience. An experienced driver will have a better understanding of how the vehicle acts in various situations and will be more likely to react to changing driving conditions without consciously thinking about the corrective measures necessary.

In contrast, a young or inexperienced driver may lack the knowledge of how much turn of the steering wheel is required to make a minor adjustment in direction. A young or inexperienced driver may also required conscious thought about how to react to changing driving conditions, while an experienced driver may make corrections without any conscious thought. Thus, a young or inexperienced drive needs to keep their entire attention focused on driving.

A driver driving a type of vehicle to which they are not accustomed must also pay additional attention while driving. The ability to react to a potential emergency is further compromised if the drive does not appreciate how the automobile operates. For example, a person who is used to driving a small car will often not react appropriately when driving a large sport utility. The larger vehicle will often require additional distance to come to a complete stop. The larger vehicle may also be more susceptible to rolling over if the driver overcorrects or attempts to take a corner too sharply. Thus, a driver driving a vehicle to which they are unaccustomed should not be distracted by telephone calls and the like.

While many people appreciate that they should not allow themselves to be distracted, most people will talk on the telephone despite the added risk. In fact, traffic jams and other high traffic situations which require the most attention are also likely to cause a driver to use the telephone due to the perception of time being lost in the traffic delay.

While parents may wish to limit the ability of their children to talk on a mobile telephone while driving, the parents may also wish to be able to use the mobile telephone themselves while driving the same vehicle. Additionally, parents may wish to be able to contact their children, or to find additional information about the vehicle their child is driving, while preventing the child from using their mobile telephone to talk to friends while driving.

Thus, there is a need for a system which can be used selectively to inhibit the ability of a person driving an automobile to be distracted by mobile telephone calls.

### OBJECTS AND SUMMARY OF THE INVENTION

It is an object to provide a system which can be used to prevent a driver from engaging in a mobile telephone call while driving an automobile.

The above and other objects of the present invention are accomplished in a system which is mounted in a car to thereby selectively jam mobile telephone signals.

In accordance with one aspect of the invention, a mobile jamming device is mounted in the car. When activated, the mobile jamming device inhibits the ability to send or receive a mobile telephone call. Depending on the wattage of the device (or the use of a directional antenna), the zone in which the mobile telephone is jammed may be controlled. Thus, for example, the device may be set to effectively jam mobile telephone calls for a space of 3-4 feet from the location of the jamming device, or in a direction which interferes with the ability of the driver to take a telephone call, but not interfere with other passengers' ability to receive or initiate a mobile telephone call.

This may be accomplished by positioning the antenna under the dashboard of the vehicle or up the driver's side of the windshield. Alternatively, a directional antenna could be placed in the driver's seat to interfere with the driver making calls. By preventing the driver from engaging in a mobile telephone call, the driver is more likely to pay attention to traffic and less likely to be distracted by the conversation.

In accordance with another aspect of the present invention, the mobile telephone jamming system may be configured to be selectively activated and deactivated. Thus, for example, a parent could selectively activate the cell phone jamming system when the automobile is used by a teenager. The system would prevent the teenager from engaging in a mobile telephone conversation while the vehicle is being driven. However, once the parent is driving the vehicle, the mobile telephone jamming system can be deactivated so as to enable the parent to engage in mobile telephone conversations while driving the vehicle.

Selective activation and deactivation could happen in a variety of ways. In a simple implementation, deactivation could occur by simply entering a pass code which would be known to parents, but not the teenager who occasionally drives the vehicle. Thus, if a parent wished to operate the vehicle and to use a mobile phone, the parent could simply enter the pass code and deactivate the system. Unless the system was deactivated it would prevent the driver from engaging in a mobile telephone conversation while driving.

In a more advanced system, a biometric reader, such as a fingerprint scanner or a retinal scanner could be used. The scanner can be used to ensure that the person attempting to deactivate the system has the authority to do so. It could also be used so that a parent wishing to deactivate the system while driving could do so would not have to look down to enter a pass code.

In yet another aspect of the system, the control for the mobile telephone jamming system could be contained away from the jamming device, such as in the trunk of the vehicle. The system could include a remote communications means, such as its own mobile telephone link, which could be accessed by a call from the parent. Thus, if a parent needs to speak with the child driving the car, the mobile telephone jamming system can be accessed remotely and turned off. Once the communication is complete, the system can be remotely turned back on to prevent further use of the system by the teenager.

In accordance with another aspect of the invention, the mobile telephone jamming system can be configured so as to only operate when the vehicle is being driven. Thus, for example, the system can be disposed in communication with the ignition system of the vehicle or the gear box of the car. If the automobile is turned off or in park, the mobile telephone jamming system will not jam a mobile signal. Thus, for example, the mobile telephone jamming system would not prevent a call in an emergency, such as after an accident, etc., but would prevent a telephone call while the car is being driven.

Likewise, the mobile telephone jamming system can be disposed in communication with one or more sensors which detect movement of the vehicle. Thus, for example, the mobile telephone jamming system could operate anytime the car is moving more than a predetermined speed. Thus, an individual who had been in an accident would be able to use their mobile telephone to contact police or emergency vehicles even if the vehicle is still running, while a person driving a vehicle in ordinary course would be prevented from taking or initiating mobile telephone calls.

Additionally, the mobile telephone jamming system could be configured for intermittent disruption of mobile signals. Thus, for example, the mobile system may jam signals for 1-10 seconds and then stop jamming signals for 30 seconds. This would allow a mobile telephone to ring so that the person could know that they have a call. However, the frequency of the jamming would be sufficient enough that it would not be feasible to carry on a conversation of any length while driving. Thus, upon hearing their mobile phone ring, the user would pull off the road and take the call.

The mobile telephone jamming system could also be configured to be deactivated if the user of a mobile telephone dials 911. Typically the telephone jamming frequency would prevent a telephone's signal from reaching a communications cell for placing the call. Many telephones, however, are equipped with a secondary communications protocol, such as BLUETOOTH which is used to convey signals to an earpiece etc. The mobile telephone jamming system could be configured with a BLUETOOTH receiver, such that the signals for dialing 911 are detected by the system and the system deactivated for the call. In the alternative, a sensor which would detect the auditory tone for dialing 911 could be used to deactivate the system.

The mobile jamming system can also be integrated into a more complete vehicle control system. Such a system could be combined with GPS vehicle tracking systems which allow users to monitor the location, speed and movement of their vehicles. The system may also be in communication with the ignition of the vehicle so that the parent could remotely terminate the ability of a teenager to drive the vehicle. Thus, for example, a parent could either program the system or remotely turn off the vehicle during hours in which the teenager is to be in school, or after the teenager's curfew.

### BRIEF DESCRIPTION OF THE DRAWINGS

Various embodiments of the present invention are shown and described in reference to the numbered drawings wherein:

FIG. 1 shows a schematic view of an automobile having a mobile jamming system disposed therein;

FIG. 2 shows a function diagram of a mobile telephone jamming system in accordance with the present invention;

FIG. 3 shows another functional diagram of a mobile telephone jamming system in accordance with the principles of the present invention;

FIG. 4 shows another functional diagram of a mobile telephone jamming system in accordance with the principles of the present invention;

FIG. 5 shows another functional diagram relating to selective actuation of the jamming system;

FIG. 6 shows a timed mobile telephone jamming system; and

FIG. 7 shows a side view of a car having a mobile telephone jamming system disposed therein; and

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims. It will also be appreciated that various aspects of the invention may be discussed or shown separately but may be coupled with other aspects of the invention in a single embodiment. Thus, the individual figures should not be viewed as distinct inventions, but rather as showing portions of the invention as a whole. Furthermore, it will be appreciated that various embodiments will achieve various aspects of the invention and these aspects should not be viewed as limiting the appended claims.

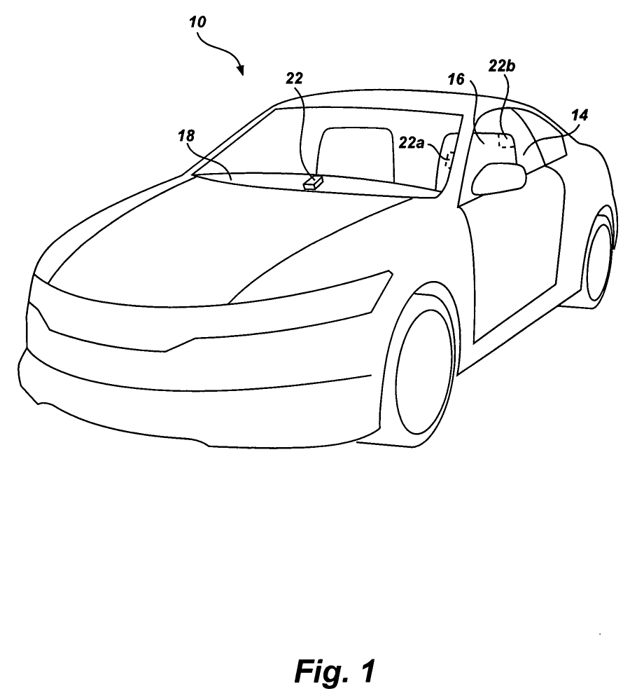

Referring now to FIG. 1 there is shown an automobile, generally indicated at 10. The automobile 10 includes a cabin 14 in which an individual sits in a seat 16. It will be appreciated in accordance with the present invention that the term automobile here is used broadly and is meant to include cars, trucks, sport utility vehicles, and other vehicles which may be driven on a road.

Disposed on or in a dashboard 18 of the automobile 10 is a mobile telephone jamming system 22. Alternatively, at least a portion of the mobile telephone jamming system—such as the antenna 22a—may be placed along the windshield, preferably on the driver's side.

It will be appreciated that a mobile telephone jamming system 22 may be placed in a variety of other locations within the automobile, such as the use of a directional antenna 22b in the seat 16. However, it may be desirable to place the mobile telephone jamming system as close to the driver as possible. This allows the wattage used by the mobile telephone jamming system 22 to be minimized and prevent interference with those in other vehicles, or even other persons in the same vehicles. In some vehicles, this may also allow persons in the passenger seats to use a mobile telephone while the driver is unable to.

The mobile telephone jamming system 22 is designed to jam signals of certain frequencies, such as the frequencies used by mobile telephones. By interfering with these signals, the mobile telephone jamming system can either completely block the ability to receive or send a call on a mobile phone, or sufficiently interfere with the mobile telephone signal so as to make the mobile telephone call undesirable. For example, if the signal is simply sufficient to interrupt a sufficient portion of the conversation, many teenagers will simply either postpone the conversation or pull over so the conversation can continued uninterrupted.

The mobile telephone jamming system is particularly beneficial for use in automobiles which are driven by teenagers. Teenagers typically have much less driving experience than adults. Additionally, many teenagers are more prone to protracted telephone conversations. The combination of these two elements increases the likelihood that teenagers will become involved in an accident due to use of a mobile telephone.

It is desirable to minimize the wattage associated with the mobile telephone jamming system 22 so as to not interfere with the mobile telephone discussions of people in other vehicles. Many mobile telephone jamming antennas are capable of jamming calls up to 30 or 50 feet or more. Obviously, it would not be desirable to jam the ability of others to make calls in the event of an emergency, etc. Thus, it is one aspect of the present invention to limit the wattage of the telephone jamming system to thereby substantially confine the jammed area to the cabin 14 of the automobile 10. Preferably, the jamming is limited to about 2-4 feet.

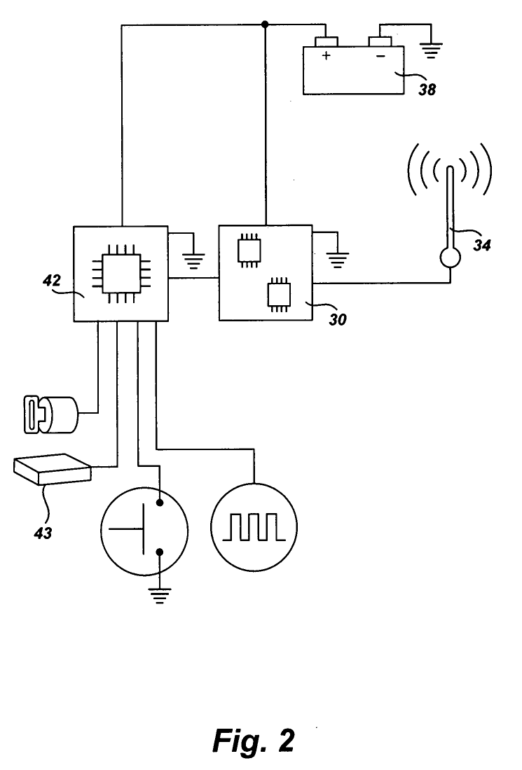

Turning now to FIG. 2 there is shown a schematic view of a telephone jamming system. The system typically will involve telephone jamming circuitry 30 which is disposed in communication with an antenna 34. The antenna emits a jamming signal to thereby disrupt mobile telephone signals and prevent or otherwise interfere with the ability to take or receive a mobile telephone call. The telephone jamming circuitry 30 and antenna 34 may be powered by the electrical system of the vehicle, or may be powered by its own battery 38. Disposed in communication with the mobile telephone jamming circuitry 30 is a control module 42. The control module may be disposed in communication with a system of the automobile, such as the ignition system, the gear box, or a variety of sensors. Thus, the mobile telephone jamming circuitry can be activated when the vehicle is turned on, when the vehicle is moved out of park or otherwise put in gear, or when one or more sensors detect that the vehicle is moving. Using a sensor to detect movement of the car would be advantageous in that it would allow a person who had been involved in an accident to immediately call the police or for emergency assistance even if the vehicle is still running.

The control module could also be configured with an emergency override 43. Thus, for example, a person who needed to make an emergency telephone call could press a button which would temporarily disable the system for some period of time. The individual could then place a call using the mobile phone's emergency calling feature, such as pressing and holding the number 9. Once the call was complete, the system could them reactivate and continue blocking calls. Obviously, several different approaches could be used to ensure that persons were not simply overriding the feature every time they wished to make a call. The system could allow for only a limited number of overrides and could send a signal to a remote location, such a telephone of the car owner, advising of the entry of an emergency override. Thus, if a teenager were using the emergency override to make telephone calls, a parent would be notified of the situation.

In the alternative, the override 43 could be configured to determine that a call had been placed to 911 and allow the call to proceed. This could happen, for example, by the use of a BLUETOOTH enabled telephone. The emergency override 43 could operate on a BLUETOOTH protocol and detect the driver dialing 911 and deactivate the system. In the alternative, a sensor would be used which detects a person dialing 911 by the auditory tones associated with those numbers and deactivate the system.

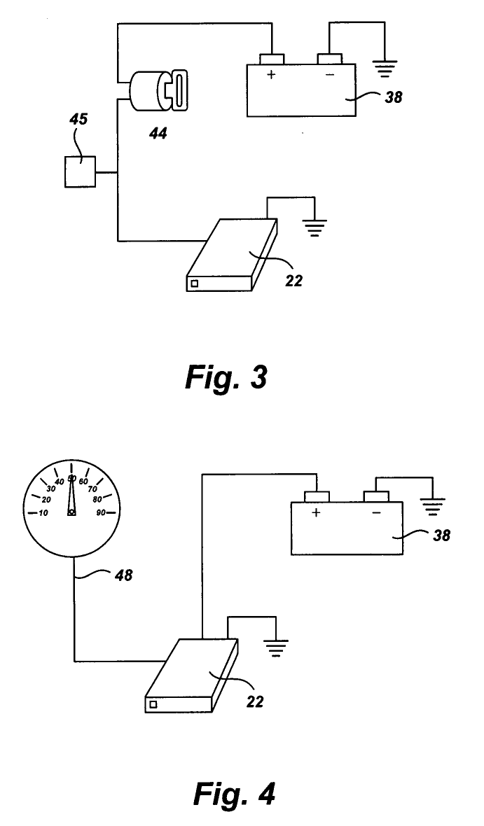

Turning now to FIG. 3, there is shown a functional diagram of the mobile telephone jamming system 22 disposed in communication with a power source 38 and with the ignition switch 44 of gearing 45 of an automobile. The mobile telephone jamming system 22 is activated by turning the ignition switch 44 into the on position, or by moving the vehicle into gear. If the ignition switch 44 is turned off, of the vehicle is in park, the mobile telephone jamming system 22 is turned off and calls can be made without interference.

FIG. 4 shows an alternate system for activating the mobile telephone jamming system 22. Rather than relying on the ignition switch, the mobile telephone jamming system 22 is disposed in communication with a sensor 48, such as the speedometer, to determine when the car is in motion or traveling over a certain speed. In this manner, the car does not need to be turned off in order to use the mobile telephone. Such may be important, for example, in an accident where the vehicle is still running, but the driver needs to make a call for emergency crews to come to the scene of the accident.

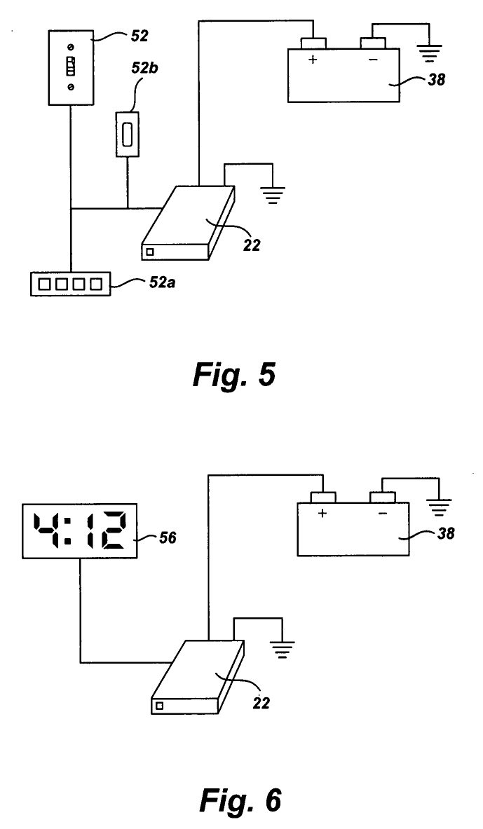

The mobile telephone jamming system 22 can also include a switch 52 to allow the system to be selectively turned off, as shown in FIG. 5. Thus, for example, a switch could be placed in the glove box or other compartment of the car. A “valet” key can be given to a teenager which does not permit access to that compartment, while the regular key will enable an adult to access the compartment and turn off the mobile telephone jamming system.

A variety of other switches may be used. For example, a switch in the form of a keypad 52a may be used. By entering a password or code a person can override the system. Thus, for example, a patent using the automobile can override the mobile telephone jamming system 22 when he or she uses the car, only to have the system reset once the car is turned off.

Likewise, other forms of switches may also be used. Switch 52b is a biometric scanner, such as a fingerprint scanner or a retinal scanner. The biometric scanner 52b may be easier to use than typing in a code, especially while the automobile is in motion. The use of any of the switches allows the mobile telephone jamming system to be turned off when the owner of the vehicle does not want the telephone jammed.

FIG. 6 shows a functional diagram of an mobile telephone jamming system 22 that is time based. A clock 56 can be used to periodically activate the system. Thus, for example, every thirty or sixty seconds the mobile telephone jamming system 22 would interfere with the ability of a mobile telephone in the automobile to send or receive a signal. The interruption may be very short, 1-10 seconds or less, but sufficient to interfere with the conversation or terminate the call. The interim period could be used for short emergency calls or would enable an emergency call to be made and once detected by the system, continued. However, the frequent disruption would provide a disincentive to use the mobile telephone while driving, especially by teenagers.

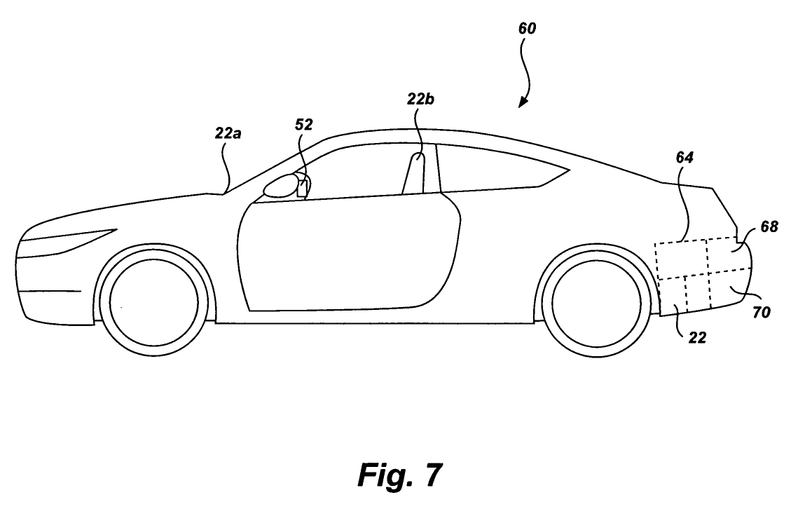

Turning now to FIG. 7, there is shown a side view of a vehicle, generally indicated at 60, which has a mobile telephone jamming system 22 formed therein. The mobile telephone jamming system 22 typically includes a jamming antenna 22a or 22b which is disposed in the vehicle. As mentioned above, the antenna 22a is preferably disposed near the driver, such as on the driver's side of the windshield or in the diiver's headrest or seat.

A switch 52, such as a simple on/off switch, a keypad or a biometric reader may be included to allow a person with authorization to turn off the mobile telephone jamming system 22. As will be explained later, the mobile telephone jamming system 22 may also include a remote mechanism for turning the system off or on.

Also shown in FIG. 7 is a master control unit 64. The master control unit 64 can be configured in accordance with any of the configurations discussed in the previous embodiments as to who the system is activated. Additionally, the master control unit 64 includes a receiver or transceiver 68 which allows remote communication with the mobile telephone jamming system 22. The transceiver 68 is either operated at a frequency or is disposed in a location such that the transceiver will not be interfered with by the jamming signals from the antenna 22a or 22b. This allows the transceiver 68 to be contacted to turn on or off the mobile telephone jamming system 22 from a remote location. Thus, a parent can contact the mobile telephone jamming system 22 and selectively activate or deactivate the system. If the parent needs to speak with a teenager driving the vehicle, he or she need only contact the transceiver 68, such as by calling and entering a code, to turn off the mobile telephone jamming system 22. He or she can then call the teenager and relay a needed message. Thereafter, another call can be used to reactivate the system so the teenager will not call friends, etc.

The master control unit 64 can also be configured to automatically deactivate the mobile telephone jamming system 22 if a crash is detected (i.e. airbags are deployed, or other crash sensors activated). It can also work in conjunction with known vehicle monitoring systems 70 which are used by many companies to monitor the location, speed and direction of movement for their vehicles. These can work either when a parent accesses the system to check on the vehicle, or be configured to text or call the parent if some parameter (such as speed or geographic area) is violated.

Parents could log into existing websites to find information regarding where the automobile is located. If the automobile is in a location which is inappropriate or is traveling at unsafe speeds, etc., the parent can remotely deactivate the system and call the driver to warn the driver to follow posted speed limits or to return to the area in which they have driving privileges etc. Thus, for example, a parent who learns that the vehicle is being driven during school hours could contact their teenager and tell them to return to class. The system could also be used to remotely turn off the vehicle during times in which it should not be driven.

Thus there is disclosed a mobile telephone jamming system which can be used to reduce unsafe driving by teenagers or others by selectively interfering with the use of mobile telephones by the driver. Those skilled in the art will appreciate that numerous modifications can be made without departing from the scope and spirit of the invention. The appended claims are intended to cover such modifications.

1. A method for reducing use of mobile telephones in an automobile comprising:
disposing a mobile telephone jamming system in an automobile, the mobile telephone jamming system being configured to interfere with use of a mobile telephone by the driver; and
allowing an authorized person to selectively deactivate the mobile telephone hamming system while the vehicle is being driven.

2. The method according to claim 1, wherein the mobile telephone jamming system is disposed in communication with at least one of an ignition switch, a gear box, a speedometer or a motion sensor in the automobile to activate the mobile telephone jamming system when the ignition switch is turned on.

3. The method according to claim 1, wherein the mobile telephone jamming system comprises an antenna configured to jam only telephone communications of a driver of the automobile.

4. The method according to claim 2, wherein the mobile telephone jamming system is configured to activate when the automobile exceeds a predetermined speed.

5. The method according to claim 1, further comprising a clock for periodically activating the mobile telephone jamming system.

6. The method according to claim 1, wherein the method further comprises providing a switch for selectively turning off the mobile telephone jamming system.

7. The method according to claim 6, wherein the switch comprises a biometric scanner.

8. The method according to claim 7, wherein the switch comprises a receiver configured to enable remote activation or deactivation of the mobile telephone jamming system.

9. The method according to claim 1, wherein the mobile telephone jamming system is configured to deactivate in the event of an accident.

10. The method according to claim 1, wherein the mobile telephone jamming system is configured to deactivate if a person in the automobile dials 911.

11. A mobile telephone jamming system comprising:
an antenna for jamming telephone communications, the antenna being configured for placement adjacent a driver of an automobile;
a deactivation means disposed in communication with the antenna to deactivate the antenna if the automobile is not being driven; and
a switch for enabling an authorized person to selectively turn off the mobile telephone jamming system.

12. The mobile telephone jamming system of claim 11, further comprising a receiver for receiving a remote signal to turn off the mobile telephone jamming system.

13. The mobile telephone jamming system of claim 12, wherein the receiver is configured to receive a telephone call and wherein the receiver is placed out of range of the antenna so as to not be jammed by emissions from the antenna.

14. The mobile telephone jamming system of claim 11, wherein the mobile telephone jamming system is configured to deactivate when a person in the automobile dials 911.

15. The mobile telephone jamming system of claim 11, further comprising a system for locating the automobile.

16. The mobile telephone jamming system of claim 1 further comprising a system for determining the speed of the automobile.

17. A mobile telephone jamming system comprising:
an antenna disposed in an automobile for producing a jamming signal for selectively jamming telephone communications of a driver of the automobile;
control circuitry for turning off the jamming system when the automobile is not moving; and
a receiver for receiving remote instructions to deactivate the mobile telephone jamming system.

18. The mobile telephone jamming system of claim 17, further comprising a biometric scanner for turning off the mobile telephone jamming system.
